(19) United States
(12) Patent Application Publication
(10) Pub. No.: US 2004/0031844 A1
(43) Pub. Date: Feb. 19, 2004

(54) Method and apparatus for the production

(76) Inventor: George Gerou, Athens (GR)

Correspondence Address: GEROU GEORGE, VALTINON 24, ATHENS, 11473, GR

(21) Appl. No.: 10/637,332

(22) Filed: Aug. 5, 2003

(30) Foreign Application Priority Data
Aug. 14, 2002 (GR) 20020100380

(51) Int. Cl. G06K 1/00; B26D 1/12

(52) U.S. Cl. 234/42; 83/676

(57) ABSTRACT

Method and apparatus which is constituted from two parallel cylinders and a recording surface, which is unfolded by the one and is wrapped around the other cylinder, connected with a mechanism to the keyboard of piano

For recording of music and production of sheet music in columns it is placed in the apparatus straight line of graphic tools above the surface of recording and vertical in its movement, each one is activated by the corresponding key while it records the corresponding note.

For the reproduction of recorded music in the place of graphic tools are placed photocells for each column of notes which is sensitised when the note go through, therefore intermediary mechanism changes the signals of photocells in attractions or impulses of his corresponding keys.

The apparatus appears in the optical field of the performer sheet music with traditional or proportional notes or sheet music in columns for the easy learning of music.

### DESCRIPTION OF THE INVENTION

The Field of the Art

The present invention relates to a method and apparatus for the recording, reproduction and display of music by means of proportional musical notation and refers to the technical field of music in general and in particular in the following areas thereof:

1. The production of new forms of notes, which are, herein referred to as proportional notes, and have the possibility to depict, with a relative accuracy the duration as well as the intensity of the musical sounds.

2. The production of a music sheet, a) by means of the substitution of conventional notes within the conventional stave with the proportional notes of the invention, and b) by means of new forms of a music sheet with proportional notes therein.

3. The direct automatic recording of music, by means of special devices, in a music sheet with proportional notes, being played in a piano or an organ.

4. The facilitation of the reading of a music sheet by making use of a means for displaying the same within the student's or performer's visual capacity.

5. The direct automatic reproduction of music in a piano or an organ, by means of a device wherein an input of a music sheet written with the proportional musical notation is being provided.

### BRIEF DESCRIPTION OF THE DRAWINGS

FIG. 1 shows the correspondence of conventional musical notes appearing in line 1 with the proportional notes of line 2 and the proportional notes with lateral contractions of line 3.

FIG. 2 shows a sheet music being written in the format of conventional notes.

FIG. 3 shows a sheet music being written in the format of proportional notes.

FIG. 4 shows a sheet music written in the format of proportional notes in columns corresponding to the keys of a piano or organ.

FIG. 5 shows a sheet music being written in columnar proportional notes, which through a reduced scale correspond to the keys of the piano.

FIG. 6 shows a device for the direct recording of music.

FIG. 7 shows a detail of the device of FIG. 6 with four rollers.

FIG. 8 shows a detail of the device of FIG. 6 with recording tools being mounted at the bottom surface of the keys.

FIG. 9 shows an alternative embodiment of the device of FIG. 6 for the indirect recording of music.

FIG. 10 shows the recording device of FIG. 9 being located within the optical field of the performer.

FIG. 11 shows a detail of the device of FIG. 9.

FIG. 12 shows a detail of a motion transmission mechanism incorporating an angular sheet metal.

FIG. 13 shows a variant of the recording device of FIG. 9 incorporating an electrical power supply.

FIG. 14 shows a variant of the device of FIG. 13, wherein an angular metal sheet is employed for the activation thereof.

FIG. 15 shows a variant of the recording device incorporating a computer.

FIG. 16 shows an embodiment of the device used for displaying a music sheet within the optical field of the performer.

FIG. 17 shows an embodiment of the music sheet displaying device.

FIG. 18 shows an embodiment of the device for reproduction of music being written in proportionally formatted notes employing a key pulling mechanism.

FIG. 19 shows a variant of the device of FIG. 18 employing a key percussion mechanism.

DETAILED DESCRIPTION OF PREFERRED EMBODIMENTS OF THE INVENTION

Hereinbelow will be presented the facilities offered by the present invention in connection to the mentioned claims and the attached drawings.

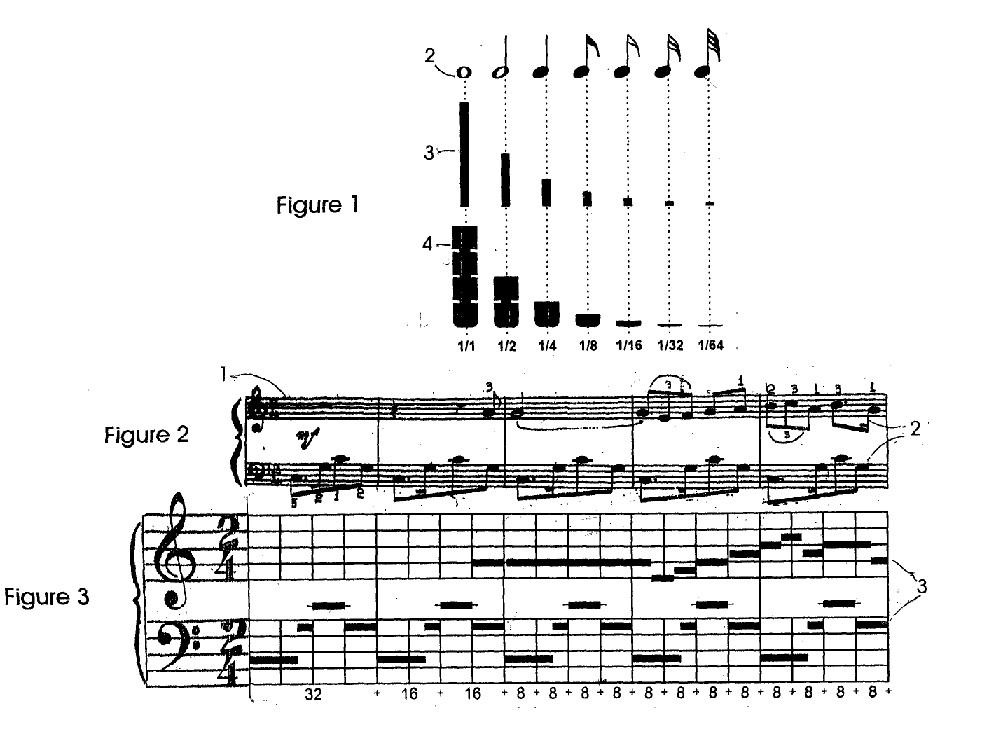

The proportional musical notes, which are produced from music recording devices, printer devices and electronic computers, are useful for the production of music sheets within the field of music education and for other purposes that are being presented hereinbelow. The proportional notes 3 and 4 (FIG. 1) are of a planar configuration with a certain length and width, wherein the length thereof corresponds to the duration of the musical sound being depicted by each one of the proportional notes and the width corresponds, at any time, to the intensity of the sound at that particular moment. Each time, corresponding units are selected for both the length and the width of the notes, so that, when such units are being applied, they clearly illustrate the dimensions of length and width of the notes. The length of the note is, therefore, expressed through the mathematical formula L=a×b wherein L is the length thereof, which equals to the product of a times b, where a is a certain length corresponding to a selected time unit and b is a number, which indicates the plurality of time units implying the duration of the sound, depicted by said note. Correspondingly, the width of a note is expressed through the mathematical formula W=c×d. W is the width of the proportional note, which equals to the product of c times d. c is a certain width, which equals a selected unit of intensity and d is a number, indicating the plurality of intensity units of the sound at a fixed moment, which is depicted by said note.

The proportional notes 4, as shown in FIG. 1 can be formed in such a manner that they present opposing contractions of their width being oriented perpendicularly to the length dimension thereof, such contractions being employed to depict sequential units of time duration of the notes. Each one of the notes 4 can bear an indication of one of the integer numbers 1, 2, 3, 4 and 5, which indicate correspondingly the thumb, the forefinger, the middle finger, the ring finger and the small one, namely the fingers being used in striking corresponding keys 7 (FIG. 4) of the musical instrument. The notes that are played by the left hand can have, as well, a different colour or a different hatching configuration than the ones played by the right hand. The correspondence between the proportional notes 3 and 4, and the traditional counterpart conventional notes 2, as well as the corresponding duration units 1/1, ½, 1/4/, ⅛, 1/16, 1/32 and 1/64 are shown in FIG. 1.

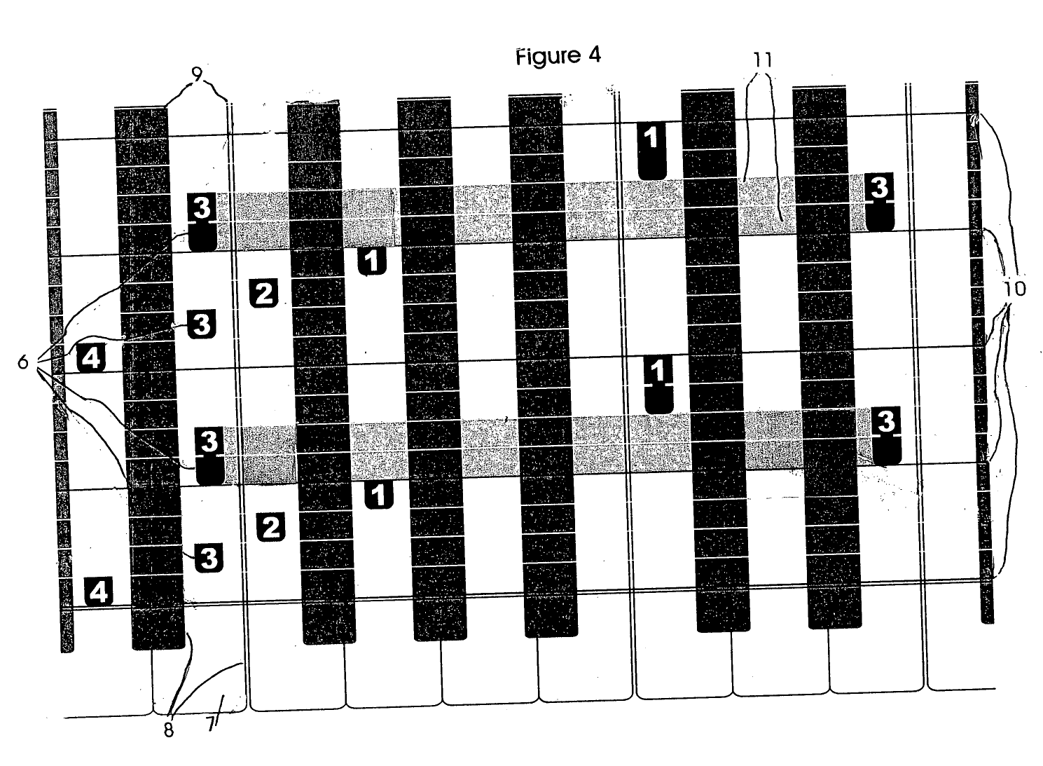

1. The production of a music sheet (FIG. 3) with proportional notes in the stave, produced by means of replacing the conventional notes 2 (FIG. 2) with the corresponding proportional notes 3 of the invention. As it has been mentioned already, the length of each proportional note is the product of a certain initial length, which is defined as the length corresponding to the duration of a time unit, equal to 1/1 or 4/4. Therefore, taking as time unit of said notes the full 1/1, and allocating a length of 64 mm to correspond to this time unit, the following lengths will result for the rest of the notes. The note that corresponds to the duration of ½ is 32 mm long, the note with a ¼-duration is 16 mm long, the note with ⅛-duration is 8 mm long, and the 1/16-duration note is 4 mm long. Thus, for the music sheet illustrated in FIGS. 3, 5, 16 mm has been taken to indicate the length unit for the note of ¼-duration, and so, the width of the bar, which herein is 2/4, equals to 2×16=32 mm. In this form of proportionally formatted music sheets, all notes are substituted, and so are the pauses, which are illustrated through a gap, so are the overstressed notes, depicted by means of enlargement of their length by 50%, and the staccato notes, which are indicated by a very intense note of a very small length. The rest of the musical symbols of the conventional musical notation remain the same.

In FIG. 4 is shown a music sheet of the invention with proportional notes arranged in columns, where the form of the music sheet is adapted according to the musical instrument in which they are to be played. Therefore, the notes of the music sheet, which are to be played in the piano or the organ, are being arranged in columns 6, each of these columns comprising the notes that are to be played on a specific one of an array of keys 7. In this way, the process of correspondence of each one of the notes to that one of the keys on which it has to be played (FIG. 4) is achieved, thereby facilitating not only students in learning how to play the piano or the organ, but also the performers.

The production of a music sheet with a direct correspondence of the proportional notes to the keys of the piano or the organ, on which these are played, can only be achieved when such correspondence between columns of notes 6 and their corresponding keys 7 is direct, and then the width of the music sheet is at a natural scale equivalent to the width of the musical instrument, thereby extending in a width such as to cover the two end keys from one to the other side of the piano or organ which take part in the performance of music, including the two small white margins on both ends. The order followed for the production of a music sheet in the natural scale of the keyboard of the piano or of the organ in which the piece of music is going to be played, is the following:

The recording surface, whereupon the proportional notes are to be printed is a paper surface that includes an arrangement of parallel lines 9 imprinted thereupon, such parallel lines defining the boundaries of columns 6 and each one of them corresponding to the separating gaps 8 in between the successive keys of the musical instrument (FIG. 4). Accordingly, if this paper recording surface is placed on the keyboard of the musical instrument, as above-mentioned, then it is very easy to correspond the side borderlines of the columns 6 with the corresponding gaps 8 between the successive keys 7. If the areas of the paper, which are situated between two successive lines, are taken as columns 6, there is therefore resulting a correspondence between the columns and the keys of the musical instrument. And for the purpose of obtaining a permanent identification of such correspondence, the term “middle Do” is being denoted on the top of the sheet music at the position of the column, whereupon middle Do notes have to be played. The notes, which, in accordance to the specific music sheet are to be played on a specific key of the musical instrument are arranged by means of a printer device, on the axis of this column that is situated precisely above the specific key. The order in which these notes appear is the same order in which they are expected to be played, following an upward-to-downward direction, which coincides with the course of their reading. The columns containing notes are separated by lines 10, oriented perpendicularly on the columns, as shown in FIG. 4. Lines 10 are the so-called distinctions in the language of music, which correspond to the beginning and end of each bar of the music sheet, as provided for by the composer. The distance between two successive distinctions equals to the sum of the length of the notes, which correspond to the duration of the bar according to the unit of length that has been corresponded to the duration unit of the unitary musical sound. A similar application of calculation of the distance between two successive bars can be seen in the case of the sheet music with proportional notes in the stave (FIG. 3). The notes, which are to be found in horizontal corresponding sections of the music sheet, are performed simultaneously in their entirety or in their separate parts, and, with a view to facilitating this synchronisation, the simultaneously performed parts thereof are being connected by means of the horizontal bands 11, shown in FIG. 4. The above-mentioned music sheet consisting of proportional notes is produced through the use of a means for the direct automatic recording of music and by means of any other relevant form of device.

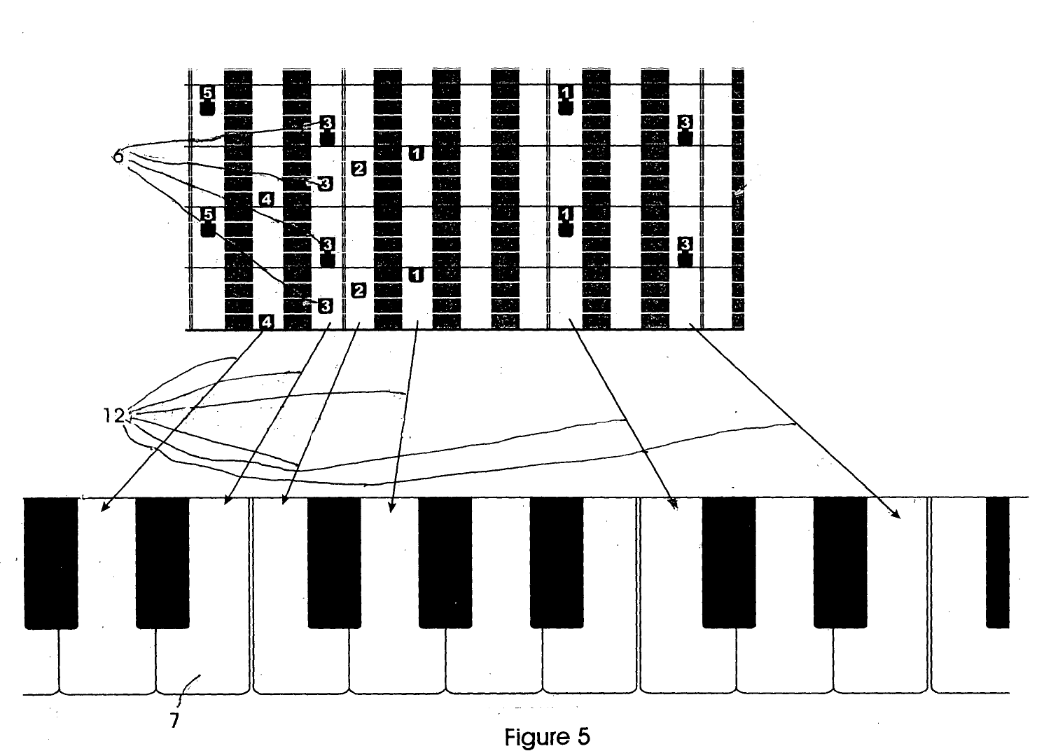

The production of a music sheet with an indirect correspondence of the notes to the keys of the musical instrument is preferred in cases, where this music sheet extends to many octaves, and in order for it to fit within a paper of a relatively small width, it is recorded in a reduced scale, as shown on the top of FIG. 5. The correspondence of the columns of proportional notes with the corresponding keys is attained by means of a radial bundle of lines 12, wherein each one of these lines 12 starts from the bottom end of a column of notes e.g. of column 6 and ends on the top of the key 7, on which the notes of this specific column should be played.

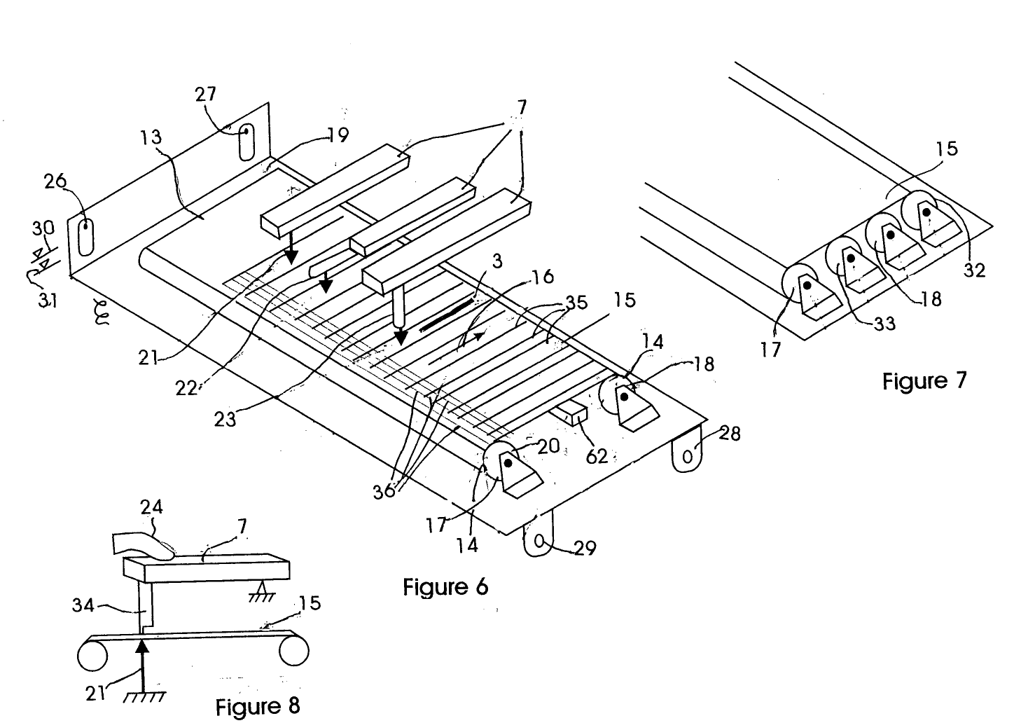

FIGS. 6 and 7 illustrate a preferred embodiment of the device for the direct automatic recording of music being played in the piano or the organ. The device is suspended underneath the keyboard of the musical instrument, and the recording is carried out onto a surface 15, which is made of paper or some other appropriate material with a width equivalent to the distance between the two end keys of the musical instrument participating in the performance of the music meant for recording, including the two small white margins on both ends. The device comprises two cylindrical rollers, namely rollers 17 and 18 with their pivotal axes extending in a direction parallel to the line of the keys. The recording surface 15, which is wound around cylinder 17, is pulled at a constant speed towards the inside of the musical instrument, as indicated by arrow 16, on top of a horizontally extending flat basement 13, which starts from and ends up to sections of cylindrical surfaces 14. Following that, this surface is wound around roller 18, which rotates clockwise with the use of an electric motor 19. A slight braking action is exerted on one of the flat sides of roller 17 by means of a metallic disc 20 tangentially mounted thereupon, which is pressed by an adjacent spring, so that the recording surface does not wind off when the latter is not drawn by the driving roller 18, but remains stretched onto the flat basement 13 thereof, during the recording of music. On top of the recording surface there is provided a serial array of drawing tools 21, 22 and 23, such as ink or colour filled drawing pens or magnetically operating pens, etc., such pens having an elastic and sharpened edge, each of them corresponding to each one of the array of keys 7 of the musical instrument, and being mounted either underneath the corresponding key as is the case with drawing pen 21 or on the extension thereof as is the case with drawing pen 22 or at the end of a wire made of steel or hard plastic reciprocatingly movable within a flexible pipe connected to the key as is the case with drawing pen 23. The distance of each drawing tool from the recording surface is such that the recording of the corresponding note is initiated at the moment that the production of the musical sound starts and is terminated at the moment that the sound is not heard anymore. Thus, each one of the drawing tools remains in contact with the recording surface, in which it records the corresponding note for as long as the corresponding key remains at a struck condition. Thus, the length of the note will be proportionate to the duration of the musical sound being produced. Depending on the force being exerted onto the keys and the corresponding force that the keys in turn exert upon the drawing tools, the drawing lines indicating said notes are thin or wide, thereby pointing out the variable intensity of the musical sound, which they have recorded.

The material used for the recording of said notes should dry out immediately, or otherwise this is achieved by using a linear electrical resistance 62, which covers the entire width of the recording surface, and is situated within a short distance from the latter. The recording surface is suspended from the musical instrument with four supports 26, 27, 28 and 29, being shown in FIG. 6, which allow the surface to be alternatively situated in two different altitudes, namely altitudes 30 and 31. Of these two alternatives, the first altitude 30 is the one defined hereinabove, whereas the second altitude 31 is lower than the first one from which it has a predetermined difference, such second altitude 31 coming forward by means of levers with the movement of the pedal of the musical instrument. With this lowering of the level of the device due to selection of the second altitude 31, because of the longer distance of the drawing tools from the recording surface, the notes being recorded thereupon are thinner, thereby indicating the lower intensity at which they are played, wherein such lowered intensity will be the same in a possible reproduction of the recorded music. The apparatus is also equipped with rollers 33 and 32 (FIG. 7), wherein roller 32 rotates freely around an axis parallel to the axis of roller 18, and is situated at a short distance from the same one to which it is almost tangential along a mutually shared generating line, in such a manner that the recording surface 15, which passes through them in a stretched condition to be drawn without sliding, thereby maintaining a constant speed of feed thereof. Finally, roller 33 serves as a means of winding of the recording surface 15, which winds around it. The alternative device with four rollers being illustrated in FIG. 7 is used in cases where the music sheet is extensively long and its winding around the driving roller 18 would lead to a significant increase in the diameter thereof, such increase resulting in the speeding up of the recording surface and in the recording of undesirably longer notes that would lead to the sheet music being false and lacking the characteristic of depicting the music being played with precision. The roller 33 is provided with motion from the driving roller 18 either by means of a belt in such a manner that the roller 33 is slidable within the belt so that it can perform fewer revolutions than the roller 18 and only as many revolutions as required for the winding of the recording surface 15 to be smoothly carried out on it, without its flow-rate being modified. The recording surface 15 is provided with an arrangement of equidistantly spaced lines 35 parallel to the direction of movement thereof, where each one of these lines is situated underneath the separating line between the successive keys of the musical instrument. The recording surface 15 is further provided with another arrangement of equidistantly spaced lines parallel lines 36, which are oriented in a direction perpendicular to the direction of movement thereof, said equidistantly spaced parallel lines being used in the calculation of the duration of each recorded note 3 (FIG. 6).

The recording of the music can also be carried out on the bottom side of the recording surface (FIG. 8), which, in this case, is transparent, so that the music sheet is readable from its topside. In this case, the series of drawing tools 21 is set in the previous position, which is symmetrical to the recording surface. The recording surface comes in contact with a corresponding one of the drawing tools each time that a member 34, which is mounted underneath a corresponding one of the array of keys 7, is pressed against it, as that key descends in order to produce a sound, thereby exerting a downward pressure through member 34 onto the recording surface, and thus, the latter comes in contact with the drawing tool 21, which records thereupon the corresponding note with a length proportionate to the duration, and a width proportionate to the intensity of the sound that has been produced. The recording of the piece of music is completed following the same procedure for each one of the sequential array of keys.

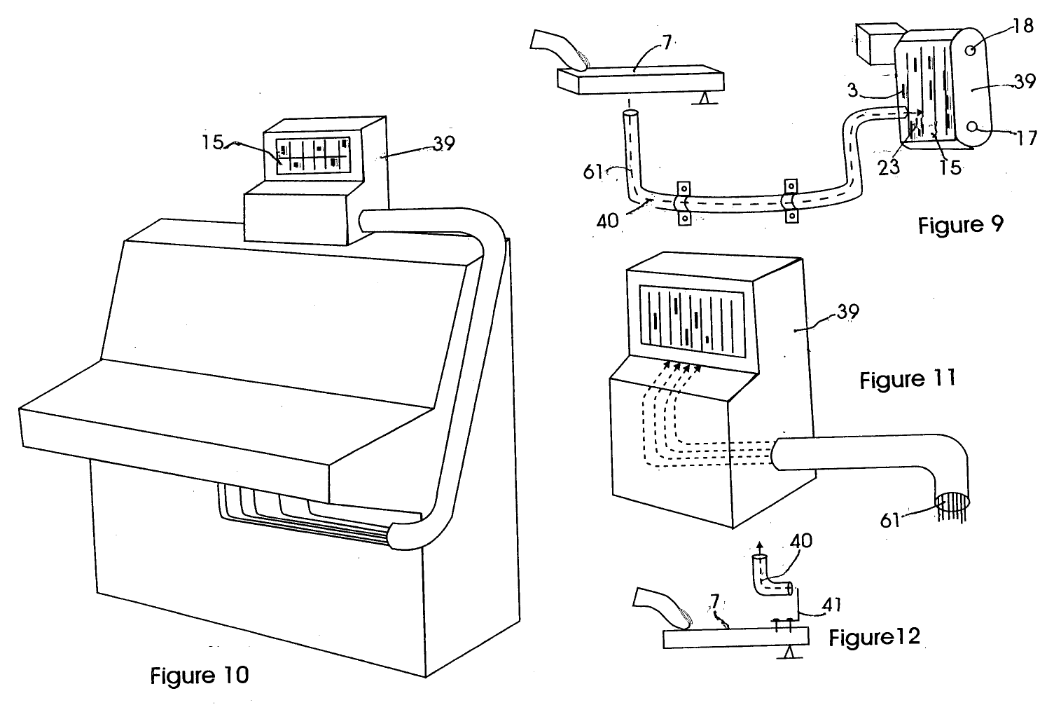

The recording of the music can be carried out indirectly using a mechanical method, that is by means of an alternative embodiment of the previously described device, namely a device 39 being illustrated in FIG. 9, in which the recording surface 15 can have desirable dimensions, selected position and inclination with respect to the horizontal level (FIG. 9), and can also be situated within the visual capacity of the performer of the music that is being recorded (FIG. 10). The device 39 is equipped with the same arrangement of roller cylinders described hereinabove, with the recording surface 15 being wound around the roller cylinder 17 and the roller cylinder 18 being the means of winding of the recording surface during the recording. The arrangement of drawing tools is also situated in a similar position with regard to the recording surface 15. The drawing tools are of the type of drawing pens 23, each one of them being connected to the end of a steel wire 40, which slides within a flexible pipe 61 that is fixedly mounted on the frame of the musical instrument. The other end of this steel wire 40 is connected to the bottom surface of the key 7 (FIG. 12). In a variation of this embodiment, the other end of the steel wire 40 is connected to the angular sheet metal 41, which is fixedly mounted on the top surface of said key 7, (FIG. 12). The device 39 and its variant operate in the same fashion as the corresponding apparatus for the direct recording of music. FIG. 11 illustrates the bundle of elastic pipes 61, which contain the steel wires 40 conveying the movements of the keys of the musical instrument to the drawing tools.

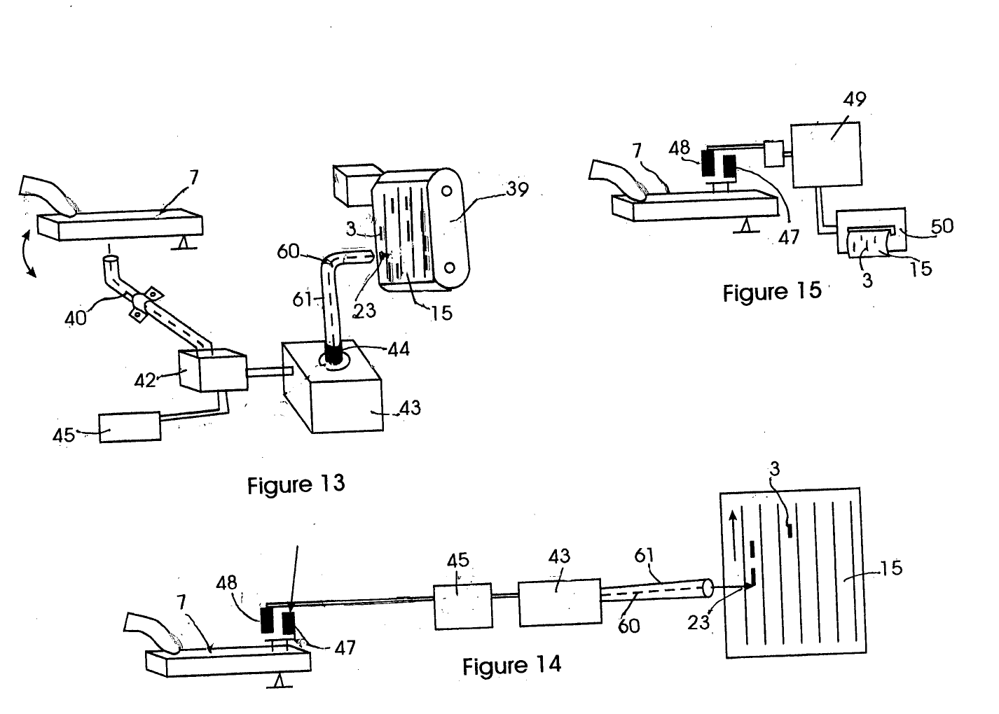

A variation of the above-mentioned device of indirect recording is the device being depicted in FIG. 13, wherein the necessary movements of the drawing tools 23 for the recording of various proportional notes 3 are being carried out by means of electric energy. The recording surface 15 is situated in a desirable position, and has desirable dimensions. The drawing tools 23 are located, as above-mentioned, in a straight line, which is perpendicular to the direction of movement of the recording surface 15. Each drawing tool 23 is also fixed on the end of a wire made of hard metal or plastic 60, which slides within a flexible pipe 61. A piston 44 of a piston-operated electromagnet 43 is provided at the other end of said wire, whereupon is mounted the drawing tool. The electric circuit is supplied with electric current via an electric power supply 45. Each time a key 7 is being struck, a switch adapted for intensity regulation 42 is activated by means of said wire 40, this switch sequentially activating the piston-operated electromagnet 43 that in turn through steel wire 60 pushes the drawing tool 23, which records the corresponding proportional note 3 on the recording surface 15. Each one of said proportionally formatted recorded notes has length and width dimensions respectively corresponding to the duration and the intensity of said notes they have been produced from.

The device illustrated in FIG. 14 constitutes an alternative variation of the device of FIG. 13 with the same arrangement and parts, with the exception of the switch adapted for intensity regulation, which is not required. Their difference lies in the method of activation of the whole system, which is here realized by means of two electric contacts, namely contacts 47 and 48. The contact 48 is connected to the electric circuit, and the contact 47 is fixed on the interior side of the angular sheet metal 41, which is fixedly mounted at the rear of the top surface of each one of said keys. The contacting surface of the electric contact 47 is elastic and cylindrical in form, so that depending on the force with which the key 7 is being struck the contact surface of the same to the electric contact 48 is varied. The greater said contact surface is, the higher is the intensity of the current passing through the electromagnet 43, that in turn presses the piston thereof with a greater force, so that, in the end, the proportionally formatted recorded note will have a width, which will be proportionate to the intensity of the sound from which it has been produced and a length proportionate to the duration of said sound.

FIG. 15 depicts one further variation of the means of music recording, wherein the keys of the piano transmit, by means of the electric contacts 47 and 48, the corresponding signals to an electronic computer 49, which activates a software program of graphics, printing corresponding proportionally formatted notes on the associated printer device.

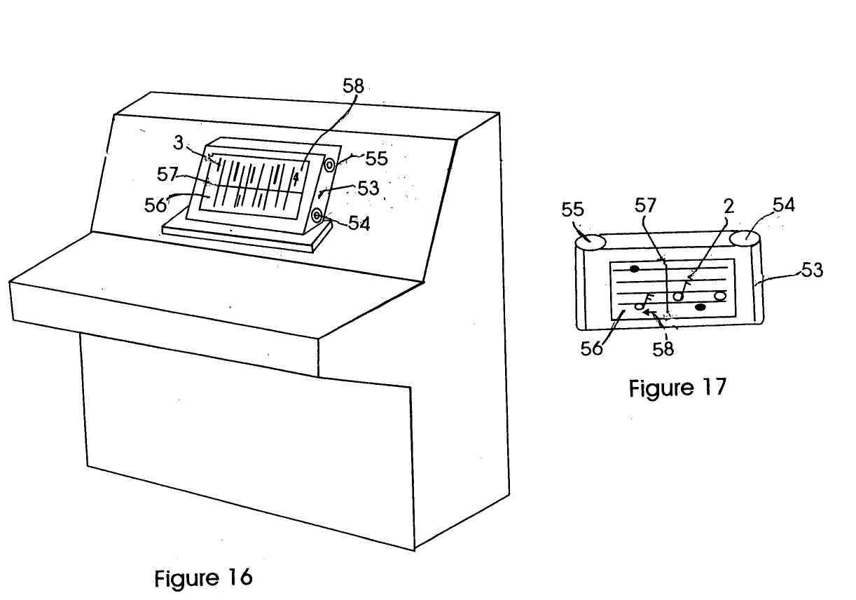

The projector means 53 for the displaying of the sheet music being produced in the aforementioned manner, as shown in FIGS. 16 and 17, constitute variants of the above-mentioned recording devices, as each one of them comprises a pair of roller cylinders without them being connected to the musical instrument. This projector means is used for displaying the sheet music either within the visual capacity of the performer of the displayed sheet music or on a monitor, by means of a projector, to be used by the performing members of an orchestra. The roller 54 is used as the drum around which is wound the sheet music, the latter being unwound during the process of reading of the music sheet, and, following that, it is being wound around the roller cylinder 55 during the operation of the device. The surface 56, oriented towards the reader's side is transparent, and is provided with a straight line 57, parallel to the axes of the abovementioned rollers thereof, such straight line indicating to the performer various elements of the sheet music being displayed on the surface. The displayed music sheet may be written either in the stave in the form of conventional notes and musical symbols or written in the form of proportional notes and printed on a paper roll, so that the staves are disposed in successive lines or in columns comprising said proportionally formatted notes, and can, thus, be played in the piano or in the organ.

In the case of a music sheet being written in a conventional stave form, the device shown in FIG. 17 comprises two vertically oriented rollers, and the music sheet “flows” in a right-to-left direction as denoted by arrow 58, and at said predetermined, but constant speed. The aforementioned line 57 indicates the order in which said notes will be performed, as well as the starting and the ending of the performance of each musical bar, that is the duration of that bar, when these bars have been drawn to scale. In the case of a sheet music written in the form of proportional notes, the utility of line 57 is enhanced, as it indicates to the performer the initiation and the termination of the performance of each one of the proportionally formatted notes, that is their duration too, and it also demonstrates the simultaneous performance of those notes that are expected to be performed simultaneously as a whole or in parts thereof. In the case of a lengthy sheet music, further rollers 32 and 33 are attached on the displaying device, and, therefore, the abovementioned devices take the form of the device shown in FIG. 7, as far as their operational part is concerned.

In the case of a sheet music written in the form of proportional notes arranged in columns that have been composed to be performed in the piano or the organ, then the device shown in FIG. 16 operates having its pair of rollers in a horizontal orientation, and the direction of movement of the sheet music is from the bottom to the top as illustrated by arrow 58 at a predetermined, but constant speed. The horizontal line 57 oriented towards the side of the reader onto the transparent surface 56 indicates to the performer not only the initiation, but also the termination of the performance of each one of said notes, as well as the simultaneous performance of those ones of said notes that are proposed to be played simultaneously as a whole or in certain individual parts thereof. The particular device also depicts clearly the varying values of intensity of each one of said notes, as long as such values are provided for each one of said notes.

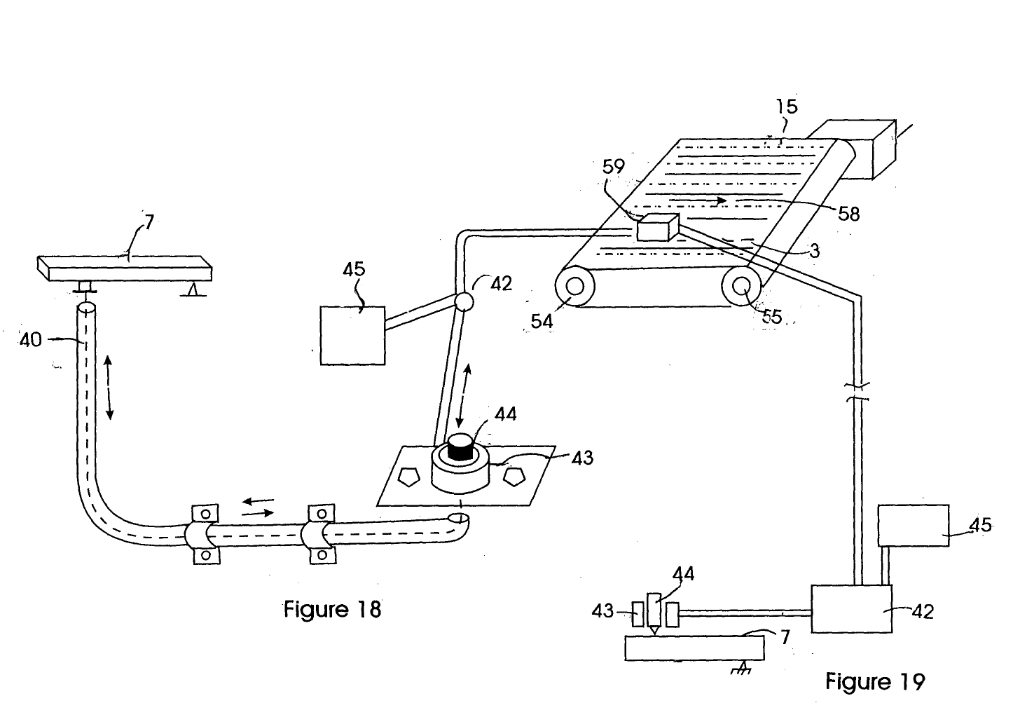

A variation of the device adapted for the recording of music, comprising a pair of rollers, can be used for the direct automatic reproduction of music performed in the piano or the organ, wherein the music is written in the form of proportional notes of the invention. The reproduction is realized in the piano or in the organ by means of pulling downwards or pressing upon the array of keys of the musical instrument without the involvement of a performer. The device shown in FIG. 18 reads, through sensor means 59, said notes 3 of a music sheet, which has been written, in the musical notation of proportional format of the invention, onto a recording surface 15, either automatically by a similar musical instrument, mechanically, by means of an electronic computer or even in manuscript, and activates the corresponding keys of the musical instrument which thereby perform the recorded music. This particular device comprises the roller 54 around which has been wound the sheet music and the roller 55, whereupon the sheet music winds during automatic reproduction process, whilst it is being performed. A sequential arrangement of sensor means 59, which are photo-electric cells or other forms of sensors arranged upon the musical instrument in a straight line, perpendicularly oriented to the direction of movement of said sheet music 58. Another group of an equivalent number of piston-operated electromagnets 43 are, by means of a switch adapted for intensity regulation 42, connected to the corresponding photo-electric cells 59 and the corresponding electrical power supply 45. A steel wire 40 is connected to the bottom surface of each one of said array of keys 7, whereas its other end is connected to the vertically oriented piston 44 of its corresponding electromagnet 43. The reproduction of the sheet music is realized by means of reading of the sheet music from the rolling surface onto which it has been recorded, which is wound around roller 54 of the device and moves towards roller 55 thereof, as indicated by the arrow 58. The notes passing through the sensor means activate the latter and each one of such activations is transformed into a signal, which causes the switch for intensity regulation 42 to switch on. That switch then allows the flow of electric current towards the piston-operated electromagnet 43. Therefore, during each one of such activation steps, the activated piston-operated electromagnet pulls upwards, with a force of proportionately applied magnitude, the piston, which, whilst rising, exerts a pulling action of the key 7 by means of the wire 40 connected therein, thereby leading to the production of the corresponding sound. The flow of the electric current lasts as long as the activation of the photoelectric cell, and is proportionate to the length of the note that is being read by the latter. Thus, the duration of the note being reproduced is equivalent to the duration of the sound from which that note has been recorded in the first place. The intensity of the electric current flowing into the abovementioned appropriately connected switch for intensity regulation is proportional to the intensity of the signal transmitted to it by the photoelectric cell, and is also proportionate to the width of the particular proportional note. Therefore, each one of the proportional notes being reproduced by the musical instrument has the duration and the intensity of the sound that has been recorded on the sheet music it has been produced from. The restoration of the piston to its initial position of rest is realized either by means of gravity or through the spring thereof. The reproduction of the entire piece of music recorded in the sheet music is achieved by means of the same procedure.

A variation of the abovementioned device for the reproduction of music, which is carried out by means of percussion of said keys of the musical instrument is shown in FIG. 19. A piston-operated electromagnet 43 is fixedly mounted on top of each one of the keys of the musical instrument. Its piston 44 is in contact with the upper surface of each one of the keys 7, and the bottom surface of the piston is semi-spherical, so that its percussion on the upper surface of each key is smoother. Those pistons, through the appropriated regulation and activation of the piston-operated electromagnets 43, can move downwards pressing the keys, and covering a distance equal to that covered by the keys themselves according to the specifications set by the manufacturer of the musical instrument. Each one of the piston-operated electromagnets 43 is activated from a corresponding sensor means 59, underneath which pass the proportionally imprinted notes of the sheet music onto which has been recorded the piece of music, thereby leading to reproduction of this piece of music as described hereinabove.

1. Apparatus for the production of a music sheet in a proportional format and reproduction of a piece of music being imprinted onto said music sheet wherein in said music sheet notes are depicted in a proportional format with successive discrete proportional traces depicting particular notes and wherein each one of said successive discrete proportional traces has a length corresponding to the duration of the sound being produced by each one of said particular notes in the music sheet and a width corresponding to the intensity thereof, comprising:
means for the direct automatic recording in a printed form of music being played in a musical instrument, said means producing a proportionally formatted piece of music constituted by successive discrete proportional traces in response to striking successive keys of the musical instrument corresponding to particular notes in the music sheet,
means for the reading of music being recorded in a proportional format by said means for the direct automatic recording in a printed form of music being played in a musical instrument, said means successively displaying at a predetermined speed said proportionally formatted piece of music for the performance thereof, and
means for the direct automatic reproduction of music being recorded in a proportional format by said means for the direct automatic recording in a printed form of music being played in a musical instrument, said means providing a sequential input of particular notes to be automatically played in a musical instrument in response to mechanical reading of said proportionally formatted piece of music.

2. Apparatus for the production of a music sheet in a proportional format and reproduction of a piece of music being imprinted onto said music sheet as claimed in above claim 1, wherein said means for the direct automatic recording in a printed form of music being played in a musical instrumental comprises:
a plurality of drawing pens with a sharpened edge, each one of said drawing pens corresponding to one key in an array of successive keys of the musical instrument,
means of linking each one of the array of successive keys of the musical instrument with each one of the plurality of said drawing pens,
a recording surface whereupon are printed successive discrete proportional traces of said drawing pens forming said proportionally formatted piece of music, said recording surface being rotatably mounted and moving horizontally at constant speed between a pair of rollers, wherein said recording surface is wound around one of said pair of rollers prior to initiation of recordal thereupon and has a free end fixedly connected to the other one of said pair of rollers, a motor being employed to rotate one driving roller of said pair of rollers at a constant predetermined speed, each one of said plurality of drawing pens being activated to conduct a drawing operation for imprinting a proportional trace onto said recording surface as it moves at said constant predetermined speed when the key it is being linked with is struck, wherein said proportional trace has a length corresponding to the duration of the sound being produced by said key and a width corresponding to the intensity thereof, and wherein said recording surface is provided with a first arrangement of equidistantly spaced parallel lines in the direction of the movement thereof, said first arrangement of equidistantly spaced parallel lines corresponding to the intelligible lines of separation amongst said successive keys of the musical instrument and a second arrangement of equidistantly spaced parallel lines being normally oriented to said first arrangement of parallel lines, wherein said second arrangement of equidistantly spaced parallel lines provides a means of establishing the recorded duration of musical notes or pauses.

3. Apparatus for the production of a music sheet in a proportional format and reproduction of a piece of music being imprinted onto said music sheet as claimed in above claim 2, wherein said means of linking each one of the array of successive keys of the musical instrument with each one of said plurality of drawing pens is a longitudinal member comprising a wire made from steel or hard plastic, said wire being connected to the drawing pen and reciprocatingly movable within a tubular housing in response to movement of the key of said of array of successive keys of the musical instrument it is being connected with.

4. Apparatus for the production of a music sheet in a proportional format and reproduction of a piece of music being imprinted onto said music sheet as claimed in above claim 3, said longitudinal member being located underneath each key of said array of successive keys of the musical instrument in a direction perpendicular to said key.

5. Apparatus for the production of a music sheet in a proportional format and reproduction of a piece of music being imprinted onto said music sheet as claimed in above claim 3, said longitudinal member being a frontal extension in a direction parallel to each key of said array of successive keys of the musical instrument.

6. Apparatus for the production of a music sheet in a proportional format and reproduction of a piece of music being imprinted onto said music sheet as claimed in above claim 4 or 5, said longitudinal member further comprising an electric circuit including a piston operated electromagnet and a switch adapted for intensity regulation for each one of the keys of said array of successive keys of the musical instrument, an electrical power supply being connected to said electric circuit so as to close the electric circuit by means of closing the switch adapted for intensity regulation corresponding to the key being struck, the corresponding electromagnet being activated so as to initiate movement of the piston thereof and subsequently of the drawing pen being connected to this piston.

7. Apparatus for the production of a music sheet in a proportional format and reproduction of a piece of music being imprinted onto said music sheet as claimed in above claim 6, further comprising a computer and associated printer device, wherein said switch adapted for intensity regulation provides an electric signal to said computer for printing said proportionally formatted piece of music in said associated printer device.

8. Apparatus for the production of a music sheet in a proportional format and reproduction of a piece of music being imprinted onto said music sheet as claimed in above claim 2, wherein said arrangement of drawing pens is located above said recording surface.

9. Apparatus for the production of a music sheet in a proportional format and reproduction of a piece of music being imprinted onto said music sheet as claimed in above claim 2, wherein said arrangement of drawing pens is located underneath said recording surface.

10. Apparatus for the production of a music sheet in a proportional format and reproduction of a piece of music being imprinted onto said music sheet as claimed in above claim 9, wherein said recording surface is transparent.

11. Apparatus as claimed in above claim 1, wherein said means of reading of music recorded in a proportional format is adapted to be used by individual performers of said proportionally formatted piece of music, comprising a pair of rollers, a motor being employed to rotate a driving roller of said pair of rollers at a constant predetermined speed, an end of said surface whereupon has been recorded a proportionally formatted piece of music being fixedly connected to said driving roller and wound around the other one of said pair of rollers prior to initiation of performance of said proportionally formatted piece of music and being wound at said constant predetermined speed around said driving roller during performance of said proportionally formatted piece of music, a transparent surface whereupon a horizontal line is printed to indicate to the individual performer initiation and termination of one or a plurality of simultaneously appearing particular notes or pauses depicted upon said surface whereupon has been recorded a proportionally formatted piece of music, said surface being adapted to move in an upward vertical direction within the visual capacity of the individual performer.

12. Apparatus as claimed in above claim 11, wherein said means of reading of music recorded in a proportional format further comprises a projector means for displaying upon a monitor said proportionally formatted piece of music when said apparatus is adapted to be used by an orchestra performing said proportionally formatted piece of music.

13. Apparatus as claimed in above claim 1, wherein said means for the direct automatic reproduction of music being recorded in a proportional format comprises a sequential arrangement of sensor means being disposed along a line oriented normally above said surface whereupon has been recorded a proportionally formatted piece of music, said surface being rotatably mounted between a pair of rollers, a motor being employed to rotate a driving roller of said pair of rollers at a constant predetermined speed, an end of said surface whereupon has been recorded a proportionally formatted piece of music being fixedly connected to said driving roller and wound around the other one of said pair of rollers prior to initiation of performance of said proportionally formatted piece of music and being wound at said constant predetermined speed around said driving roller during performance of said longitudinally formatted piece of music, each one of said sequential arrangement of sensor means corresponding to one key in an array of successive keys of a musical instrument employed for the direct automatic reproduction of music being recorded in a proportional format and each one of said sequential arrangement of sensor means being part of an electric circuit comprising a piston operated electromagnet, a switch adapted for intensity regulation for each one of the keys of said array of successive keys of the musical instrument and an electric power supply being connected to said electric circuit so as to close the electric circuit by means of closing the switch adapted for intensity regulation corresponding to a signal being transmitted by said sequential arrangement of sensor means in response to activation of one of said sequential arrangement of sensor means corresponding to the note being depicted onto said surface whereupon has been recorded a proportionally formatted piece of music, the corresponding electromagnet being activated so as to initiate movement of the piston thereof and subsequently produce the sound corresponding to the key of the musical instrument associated with the note being depicted onto said surface whereupon has been recorded a proportionally formatted piece of music, the duration of the sound corresponding to the length and the intensity thereof corresponding to the width of the proportional trace of the particular note being depicted onto said surface whereupon has been recorded a proportionally formatted piece of music, wherein the precise measure of the width of the proportional trace of the particular note is reproduced by equivalent variation of the electric current allowed to flow in the electric circuit by means of the corresponding switch adapted for intensity regulation for each one of the keys of said array of successive keys of the musical instrument.

14. Apparatus as claimed in above claim 13, wherein said pistons are oriented normally above said sequential arrangement of keys of the musical instrument, one piston for each one of the keys of the musical instrument, each of said pistons having a rounded end in contact with the corresponding key of the musical instrument, said rounded end effecting a downward pressure of the corresponding key in response to activation of the corresponding one of said sequential arrangement of sensor means to produce the sound corresponding to the note being depicted onto said surface whereupon has been recorded a proportionally formatted piece of music as said piston moves with a stroke corresponding to the stroke of the key in said sequential arrangement of keys of the musical instrument.

15. Apparatus as claimed in above claim 13, wherein said pistons are oriented normally below said sequential arrangement of keys of the musical instrument, one piston for each one of the keys of the musical instrument, a wire made from steel or hard plastic being employed for the connection of each one of said keys of the musical instrument to the corresponding one of said pistons, each one of said pistons moving in response to activation of the corresponding one of said sequential arrangement of sensor means with a stroke corresponding to the stroke of the key in said sequential arrangement of keys of the musical instrument and pulling said key downwards to produce the sound corresponding to the note being depicted onto said surface whereupon has been recorded a proportionally formatted piece of music.

16. Apparatus as claimed in above claim 13, wherein said sensor means are conveniently selected from commercially available photoelectric cells, magnetic sensors and the like.

17. Proportionally formatted piece of music being produced by said means for the direct automatic recording in a printed form of music being played in a musical instrument, said proportionally formatted piece of music consisting of successive discrete proportional traces depicting particular notes in a music sheet, wherein each one of said successive discrete proportional traces has a length corresponding to the duration of the sound being produced by each one of said particular notes in the music sheet and a width corresponding to the intensity thereof, said proportionally formatted piece of music being printed onto a continuous roll.

18. Proportionally formatted piece of music as claimed in above claim 17, wherein said recording surface is provided with a first arrangement of equidistantly spaced parallel lines in the direction of movement thereof, said first arrangement of equidistantly spaced parallel lines corresponding to the intelligible lines of separation amongst said successive keys of the musical instrument and a second arrangement of equidistantly spaced parallel lines being normally oriented to said first arrangement of parallel lines, wherein said second arrangement of equidistantly spaced parallel lines provides a means of establishing the recorded duration of musical notes or pauses.

19. Proportionally formatted piece of music as claimed in above claim 18, being employed in the process of instruction of playing the piano or the organ wherein each one of said successive discrete proportional traces in said proportionally formatted piece of music being printed onto a continuous roll is provided with an indication of an integer number in the range of 1-5 instructing the performer of the piece of music to play the particular note bearing the indication of integer 1, 2, 3, 4 or 5 with the corresponding respectively associated finger starting with the thumb being indicated by number 1 and wherein each one of the notes being depicted in said music sheet in a proportional format is distinctively coloured in one or the other of a pair of colours indicating employment of the right or left hand in playing the particular note.

20. Method for the production of a music sheet in a proportional format and reproduction of a piece of music being imprinted onto said music sheet wherein successive discrete proportional traces depict particular notes in said music sheet and wherein each one of said successive discrete proportional traces has a length corresponding to the duration of the sound being produced by each one of said particular notes in the musical text and a width corresponding to the intensity thereof, comprising the steps of:
activating a device for the direct automatic recording in a printed form of music being played in a musical instrument, said device comprising a plurality of drawing pens with a sharpened edge, each one of said drawing pens corresponding to one key in an array of successive keys of the musical instrument, wherein each one of the array of successive keys of the musical instrument is linked with each one of the plurality of said drawing pens so that discrete proportional traces are produced by said drawing pens in response to striking of keys of said musical instrument onto an input of a recording surface moving at a constant predetermined speed underneath said array of successive keys of the musical instrument;
playing a piece music in said musical instrument and sequentially activating each one of said plurality of drawing pens to conduct a drawing operation for imprinting a proportional trace onto said recording surface as it moves at said constant predetermined speed when the key it is being linked with is struck, thereby producing an output of a continuous roll of said recording surface whereupon has been printed a proportionally formatted piece of music corresponding to said piece of music being played;
alternatively employing said output of continuous roll of said recording surface whereupon has been printed a proportionally formatted piece of music in:
reproduction of said proportionally formatted piece of music by an individual performer by scrolling at a constant predetermined speed said continuous roll of said recording surface whereupon has been printed said proportionally formatted piece of music in an upward vertical direction within the visual capacity of the individual performer playing a musical instrument;
reproduction of said proportionally formatted piece of music by an orchestra by displaying upon a monitor via a projector means said scrolling continuous roll of said recording surface whereupon has been printed said proportionally formatted piece of music within the visual capacity of all members of the orchestra playing various musical instruments;
automatic reproduction of said proportionally formatted piece of music by means of mechanical reading through an arrangement of sensors of said scrolling continuous roll of said recording surface whereupon has been printed said proportionally formatted piece of music, each one of said sensors being activated to effect via an associated piston operated electromagnet striking of a key in a sequential arrangement of keys of the musical instrument in response to appearance of a proportional trace onto said recording surface and for a length of time equivalent to the length of said proportional trace and with an intensity proportional to the width of said proportional trace.
